(19) United States
(12) Patent Application Publication
(10) Pub. No.: US 2010/0107669 A1
(43) Pub. Date: May 6, 2010

(54) THREE-WAY SOLENOID VALVE, ROTARY COMPRESSOR, AND REFRIGERATION CYCLE EQUIPMENT

(75) Inventor: Koji Wada, Fuji-shi (JP)

Correspondence Address: DLA PIPER LLP US, P. O. BOX 2758, RESTON, VA, 20195, US

(73) Assignee: TOSHIBA CARRIER CORPORATION, Minato-Ku (JP)

(21) Appl. No.: 12/686,414

(22) Filed: Jan. 13, 2010

Related U.S. Application Data
(63) Continuation of application No. PCT/JP2008/062831, filed on Jul. 16, 2008.

(30) Foreign Application Priority Data
Jul. 17, 2007 (JP) 2007-186231

(51) Int. Cl. F04C 28/24; F16K 31/06; F04C 18/356; F16K 11/07; F25B 49/02

(52) U.S. Cl. 62/196.1; 137/625.48; 251/129.15; 418/60; 417/301; 417/307

(57) ABSTRACT

A three-way solenoid valve includes a valve box in which a first valve seat and an outflow port are provided at one end and a second valve seat is provided at an apart position. A solenoid unit, provided with the valve body, is located at the other end of the valve box. A circular sealing projection divides the internal space of the valve box into a first chamber and a second chamber. A first inflow port is open in the first chamber, and a second inflow port is open in the second chamber. The first inflow port communicates with the outflow port when the valve body is in contact with the second valve seat. The second inflow port communicates with the outflow port through an internal flow path when the valve body is in contact with the first valve seat.

### CROSS REFERENCE TO RELATED APPLICATIONS

This is a Continuation Application of PCT Application No. PCT/JP2008/062831, filed Jul. 16, 2008, which was published under PCT Article 21(2) in Japanese.

This application is based upon and claims the benefit of priority from prior Japanese Patent Application No. 2007-186231, filed Jul. 17, 2007, the entire contents of which are incorporated herein by reference.

### BACKGROUND OF THE INVENTION

1. Field of the Invention

The present invention relates to a three-way solenoid valve which selects one of fluids flowing in from two directions, and leads the selected fluid to a predetermined direction, a two-cylinder rotary compressor which adopts the three-way solenoid valve, and refrigeration cycle equipment which includes the rotary compressor for constituting a refrigeration cycle.

2. Description of the Related Art

A document 1 (Japanese Patent No. 2002-181210) discloses a three-way solenoid valve for low-pressure water, which is used for supplying low-pressure water equivalent to tap water to an ice tray of a refrigerator. The valve is configured to hold a diaphragm attached closely to a valve body shaft by a body which contains first and second valve seats, and a guide in which one end of the valve body shaft is inserted, so that controlled fluid is prevented from residing or flowing out from the body into the guide, even if the valve body shaft is moved.

A document 2 (Jpn. UM Appln. KOKAI Publication No. 3-19175) discloses a three-way motor valve, which is used as a promotional control valve in a refrigeration cycle of a refrigerator or air conditioner. The valve is configured to energize a coil to rotate a rotor provided in a case, and to move a valve body in upward or downward. The valve body is configured to control a flow rate by changing the aperture areas of a valve seat formed in the lower end portion of a chamber, and a valve seat formed in the upper end portion of another chamber.

### BRIEF SUMMARY OF THE INVENTION

The three-way solenoid valve for low-pressure water disclosed in the document 1 adopts a method of directly sliding a valve body by a magnetic force. Therefore, a holding spring force greater than fluid pressure is required, and greater magnetic force is required for switching a high-pressure fluid. This is unsuitable for switching a high-pressure fluid.

The three-way solenoid valve for a high-pressure refrigerant disclosed in the document 2 requires a driving torque greater than fluid pressure, and slides a valve body by rotating a shaft by a pulse motor, to maintain sealing between a valve body and a valve seal. Therefore, the structure is complex, the control is complicated, and the size is inevitably increased.

The invention has been made in the above circumstances. Accordingly, it is an object of the invention to provide a three-way solenoid valve, which is configured to slide a valve body by a magnetic force, usable for a high-pressure fluid, simple in structure, and improves reliability; a rotary compressor which adopts the three-way solenoid valve in the refrigerant injection side of a two-cylinder compression mechanism; and refrigeration cycle equipment which includes the rotary compressor for constituting a refrigeration cycle.

In order to achieve the above object, a three-way solenoid valve according to the invention is configured to have a cylindrical valve box in which a first valve seat is provided at one end, an outflow port is opened, and a second valve seat is provided at a position apart in an axial direction from the first valve seat; a valve body which is provided movably back and forth in the valve box, and has an internal flow path whose one end is opened in the end face of the outflow port, and the other end is opened on the side; a solenoid unit which is located at the other end of the valve box, and has a plunger provided as a single unit with the valve body, and drives the valve body together with the plunger; a sealing means which seals the space between the valve box and valve body, and divides the internal space of the valve box into a first chamber opposing the first valve seat, and a second chamber opposing the second valve seat; and a first inflow port which is provided in the first chamber, and is opened in the direction substantially orthogonal to the axis line of the valve box, and a second inflow port which is provided in the second chamber, and is opened in the direction substantially orthogonal to the axis line of the valve box, wherein the first inflow port communicates with the outflow port when the valve body contacts the second valve seat, and the second inflow port communicates with the outflow port through the internal flow path of the valve body when the valve body contacts the first valve seat.

In order to achieve the above object, a rotary compressor comprises a sealed case which contains an electric motor unit, a first compression mechanism connected to the electric motor unit, and a second compression mechanism configured to apply back pressure to a vane by internal pressure of the case; and a switching means which is provided in a gas suction path connected to a cylinder chamber of the second compression mechanism, and is configured to switch connection of the cylinder chamber to a low-pressure side of a refrigeration cycle or a high-pressure side of a refrigeration cycle including a space inside the sealed case, and to lead a low-pressure refrigerant into the cylinder chamber to perform normal compression, or to lead a high-pressure refrigerant into the cylinder chamber to perform idle operation, wherein the switching means comprises the three-way solenoid valve according to aforementioned description, connects an outflow port of the three-way solenoid valve to the downstream of the gas suction path connected to the cylinder chamber of the second compression mechanism, connects one of the first inflow port and second inflow port to the upstream of the gas suction path, and connects the other ends of the first inflow port and second inflow port to the high-pressure side of the refrigeration cycle.

In order to achieve the above object, refrigeration cycle equipment according to the invention comprises the rotary compressor, a condenser, an expansion unit, and an evaporator.

### BRIEF DESCRIPTION OF THE SEVERAL VIEWS OF THE DRAWING

FIG. 1 is a schematic sectional view of a three-way solenoid valve according to an embodiment of the invention, in normal operation mode;

FIG. 2 is a schematic longitudinal sectional view of a three-way solenoid valve according to the embodiment, in special operation mode;

FIG. 3 is an explanatory diagram explaining the flow of magnetic flux in a solenoid unit in a three-way solenoid valve according to an embodiment of the invention;

FIG. 4 shows a configuration of a refrigeration cycle which adopts a three-way solenoid valve according to the embodiment in a rotary compressor; and

FIG. 5 is an explanatory diagram explaining a configuration structure of a three-way solenoid valve according to an embodiment of the invention.

### DETAILED DESCRIPTION OF THE INVENTION

Embodiments of the invention will be explained hereinafter based on the accompanying drawings.

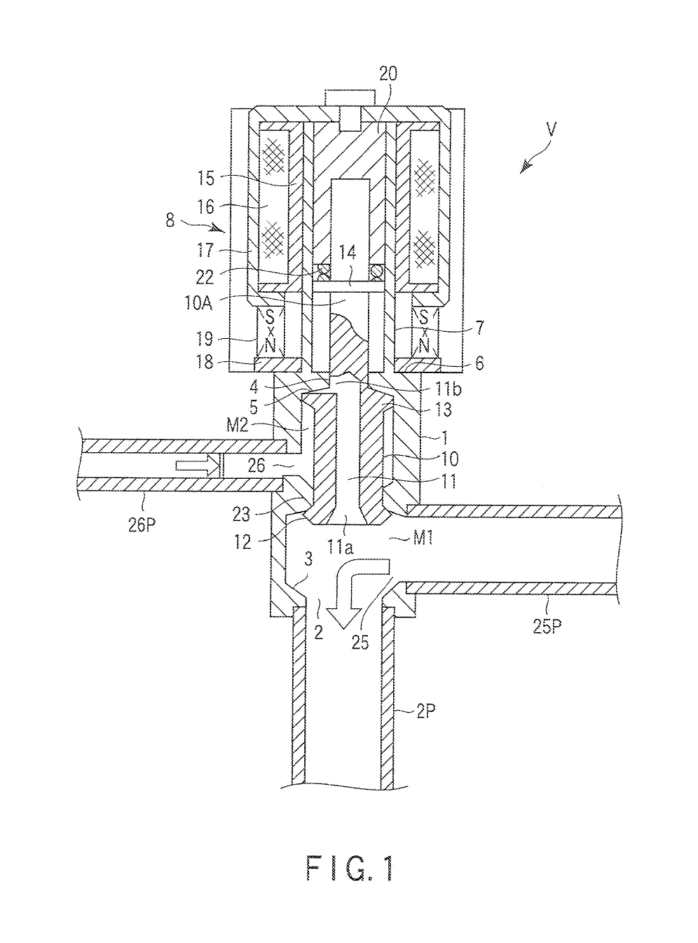

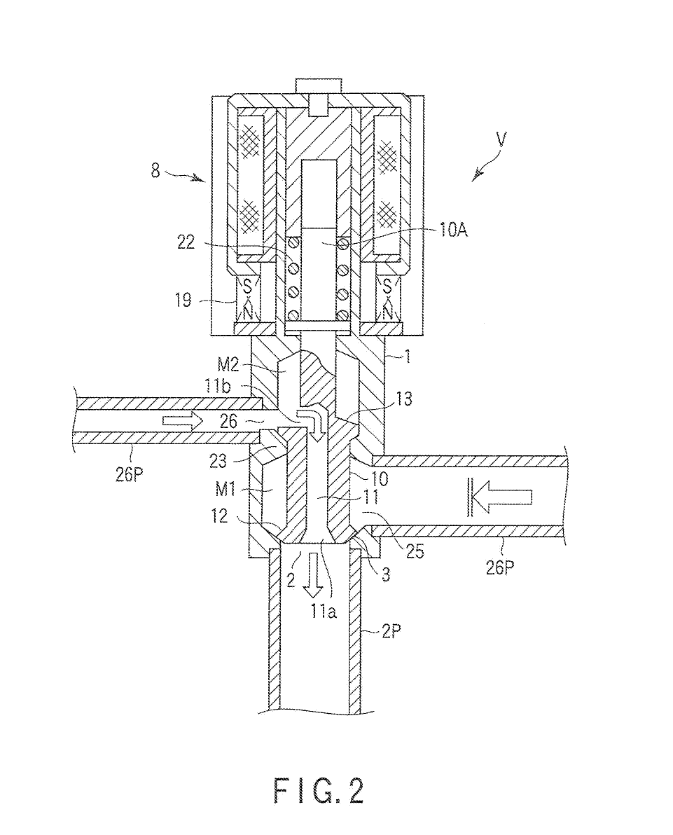

FIG. 1 is a longitudinal sectional view of a three-way solenoid valve V in normal operation mode to be described later. FIG. 2 is a longitudinal sectional view of the three-way solenoid valve V in special operation mode to be described later.

A reference number 1 in the drawings denotes a cylindrical valve box. In the lower end portion of the valve box in the drawings, an outflow port 2 is opened, and connected to an outflow tube 2P. A first valve seat 3 is provided along the outflow port 2 inside the valve box 1. An insertion hole 4 is provided in the upper end portion of the valve box 1. A second valve seat 5 is provided along the insertion hole 4 inside the valve box 1. Therefore, the second valve seat 5 is provided in the upper position apart from the first valve seat 3 in the axial direction. The valve box 1 may be molded in a single piece, or formed as a single piece from two or more members.

In the upper part where the insertion hole 4 of the valve box 1 is provided, a guide unit 7 is extended as one body through a step portion 6 having a reduced diameter. The guide unit 7 is formed cylindrical with a diameter reduced to smaller than the part where the first and second valve seats 3 and 5 are provided, and its upper end is closed. A solenoid unit 8 to be described later is provided along the outer circumference of the guide unit 7. The solenoid unit 8 is located above the valve box 1.

In the valve box 1, a valve body 10 is housed movably back and forth along the axial direction. The valve body 10 is shaped in the form of a deformed cylinder, in which a first opening 11a is provided in the end portion of the outflow port 2 that is the lower end, and a second opening 11b is provided on the side of the upper end. Therefore, the valve body 10 has an internal flow path 11 which communicates a first opening 11a with a second opening 11b.

The internal flow path 11 is L-shaped in FIG. 1. It may be T-shaped, or may be a hole inclined along the axis line of the valve body 10, as long as one end is opened to the end portion of the outflow port 2, and the other end is opened to the side.

In the valve body 10, a first valve unit 12 is provided along the peripheral edge of the first opening 11a, and a second valve unit 13 is provided along the lower peripheral edge of the second opening 11b. In FIG. 1, the first and second valve units 12 and 13 are made in the form of a circular ring projecting to the outer circumference of the valve body 10, but they are not limited to a projected circular ring.

The valve body 10 A is provided with a columnar plunger 10A as a single unit. The plunger 10A is extended upward from the second opening 11b provided in the upper part of the valve body 10. The extended part includes a flange-shaped backup plate 14 with a diameter slightly smaller than the internal diameter of the guide unit 7.

Therefore, the plunger 10A including the backup plate 14 is housed movably in the guide unit 7. The part of the plunger 10A under the backup plate 14 can be inserted into the valve box 1 through the insertion hole 4.

The solenoid unit 8 located on the outer periphery of the valve box 1 is configured to move up and down the valve 10 and plunger 10A, and constitutes a self-holding coil.

Further, an outer yoke 15 is fitted to the outer periphery downward from the upper end of the upper guide unit 7, with a predetermined clearance to the guide unit 7. A coil 16 is wound around the periphery of the outer yoke 15, and is held by a holding member 17.

A washer 18 is fitted in the step portion 6 that forms a boundary between the valve box 1 and guide unit 7, and a permanent magnet 19 is inserted between the washer 18 and outer yoke 15. The washer 18 side of the permanent magnet 19 is the north pole, and the outer yoke 15 side is the south pole.

A tube cap 20 is fitted inside the upper closed end part of the guide unit 7. A columnar part that tightly contacts the upper closed end part of the tube cap 20 is formed as one body with a cylinder unit in which a part of the upper end of the plunger 10A is movably fitted, forming a reversed-concave cross section.

A compression spring 22 is inserted between the lower end of the tube cap 20 and the backup plate 14 of the guide unit. In other words, a clearance is provided between the lower end of the tube cap 20 and the backup plate 14 of the guide unit, even if the valve body 10 is positioned at the uppermost part of the valve box 1 as shown in FIG. 1. The compression spring 22 inserted into the clearance always elastically presses and energizes the valve body 10 that is movable to the fixed tube cap 20, in the direction of the outflow port 2 that is a lower part.

Explaining again the valve box 1, an intermediate part between the first valve seat 3 and second valve seat 5 provided in the valve box 1 is opened, and a circular sealing projection (a sealing means) 23 is provided inside the opening. The circular sealing projection 23 is projected to the axis line of the valve box 1, forming a sealing surface on the upper surface, lower surface, and inside surface.

The distance between the circular sealing projection 23 and first valve seat 3 in the valve box 1 coincides with the distance between the first valve unit 12 and second valve unit 13 in the valve body 10. The distance between the circular sealing projection 23 and second valve seat 5 is designed to coincide with the distance between the first valve unit 12 and second valve unit 13.

As described later, in the state in which the solenoid unit 8 is energized or not energized, the valve body 10 is moved up and down, and one of the first valve seat 12 and second valve seat 13 contacts the circular sealing projection 23. In other words, the first valve seat 12 or second valve seat 13 of the valve body 10 contacts the circular sealing projection 23, and completely seals the space between the inside surface of the valve box 1 and the outside surface of the valve body 10.

As the valve units 12 and 13 of the valve body 10 contact the circular sealing projection 23, the inside space of the valve box 1 forms a first chamber M1 by opposing the first valve seat 3, and forms a second chamber M2 by opposing the second valve seat 5. In other words, the first and second chambers M1 and M2 are divided to upper and lower parts by the circular sealing projection 23.

In the first chamber M1, the outflow port 2 that is connected to the outflow tube 2P is provided along the axial direction of the valve box 1. In the first chamber M1, a first inflow port 25 is opened in the direction orthogonal to the direction of axis, and is connected to a first inflow tube 25P. In the second chamber M2, a second inflow port 26 is opened in the direction orthogonal to the direction of axis of the valve box 1, and is connected to a second inflow tube 26P.

A means of sealing the inside space of the valve box 1 is not limited to the circular sealing projection 23 inside the valve box. It is permitted to forma circular projection, which forms a surface to seal the inner circumference of the valve body 10, or to provide a separately-formed sealing member between the outer surface of the valve body and the inner surface of the valve box.

Next, the function of the three-way solenoid valve V will be explained.

FIG. 1 shows normal operation mode of the three-way solenoid valve, in which a magnetic force is generated by energizing the solenoid unit 8, and the plunger 10A and valve body 10 are raised against the electric force of the compression spring 22. FIG. 2 shows special operation mode, in which the solenoid unit 8 is not energized, the solenoid unit 8 does not generate a magnetic force, and the elastic force of the compression spring 22 acts on the plunger 10A, and moves down the valve body 10. In either state, a magnetic flux is always generated in a permanent magnet 19 provided in the solenoid unit 8.

First, the state of FIG. 1 is explained in detail. Magnetic force is generated by energizing the solenoid unit 8. As a result, the valve body 10 is raised against the elastic force of the compression spring, and positioned in the second chamber M2. The valve unit 13 of the valve body 10 contacts the valve seat 5 of the valve box 1, the first valve unit 12 contacts the circular sealing projection 23, and seals the space between them. Therefore, the second inflow port 26 is closed by the valve body 10.

In other words, the valve body 10 does not present in the first chamber M1, and the first inflow port 25 and outflow port 2 are kept open. Even if high-pressure fluid is led from both first inflow tube 25P connected to the first inflow port 25 and the second inflow tube 26P connected to the second inflow port 26, as the second inflow port 26 is closed by the valve body 10, the high pressure of the fluid flowing from the second inflow tube 26P to the three-way solenoid valve V is cancelled.

The high-pressure fluid flowing from the first inflow tube 25P is led into the three-way solenoid valve V through the first inflow port 25, and then led to the inflow tube 2P through the inflow port 2. In this manner, the three-way solenoid valve V selects the high-pressure fluid led from the inflow tube 25P, leads it to the inflow tube 2P, and cancels against the second inflow tube 26P.

The pressure of the high-pressure fluid flowing in the three-way solenoid valve V is received by the valve body 10, and pressed and energized upward in the drawing. The second valve unit 13 of the valve body 10 contacts more closely the second valve seat 5 of the valve box 1, and the first valve unit 12 of the valve body 10 contacts more closely the circular sealing projection 23. The above function makes sealing of the valve body 10 to the valve box 1 more complete.

Further, as described later, the magnetic force of the permanent magnet 19 in the solenoid unit 8 has an influence in the direction of raising the plunger 10A. Thus, similar to the high-pressure fluid led into the valve box, the second valve unit 13 contacts more closely the second valve 5, and the first valve unit 12 contacts more closely the circular sealing projection 23, thereby making the sealing of the valve body 10 to the valve box 1 more complete.

As shown in FIG. 2, in special operation mode, the solenoid unit 8 is not energized, and magnetic force is not generated. The elastic force of the compression spring 22 is restored, and acts on the plunger 10A, whereby the valve body 10 is moved down, and shifted from the second chamber M2 to the first Chamber M1.

The first valve unit 12 at the lower end of the valve body 10 contacts the first valve seat 3 of the valve box 1, and the upper second valve 13 contacts the circular sealing projection 23, making respective sealing. Therefore, the first inflow port 25 is completely closed by the valve body 10.

The first opening 11a of the valve body 10 is located at the same position as the outflow port 2, and communicates with the outflow port. The second opening 11b of the valve body 10 opposes the second inflow port 26, and communicates with the second inflow port. Therefore, the internal flow path 11 of the valve body 10 communicates with the second inflow port 26 and outflow port 2.

In the above state, high-pressure fluid is led from both first inflow tube 25P connected to the first inflow port 25 and the second inflow tube 26P connected to the second inflow port 26. As the first inflow port 25 is being closed by the valve body 10, the high pressure of the fluid flowing from the first inflow tube 25P to the three-way solenoid valve V is cancelled.

The high-pressure fluid flowing from the second inflow tube 26P is led to the inside of the three-way solenoid valve V through the second inflow port 26, and is further led to the first opening 11a from the second opening 11b of the valve body 10 through the internal fluid path 11. As the first opening 11a communicates with the outflow port 2, the high-pressure fluid flowing out of the internal fluid path 11 is led to the outflow tube 2P through the outflow port 2.

The pressure of the high-pressure fluid led from the second inflow port 26 into the valve box is received by the valve body 10, and pressed and energized downward in the drawing. The first valve unit 12 of the valve body 10 contacts more closely the first valve seat 3 of the valve box 1, and the second valve unit 13 contacts more closely the circular sealing projection 23. The above function makes the sealing of the valve body 10 to the valve box 1 more complete.

The permanent magnet 19 in the solenoid unit 8 has an influence on the magnetic force in the direction of raising the plunger 10A, contrarily to the compression spring 22, but the permanent magnet force is smaller than the elastic energizing force of the compression spring 22, and does not affect the function of the compression spring 22.

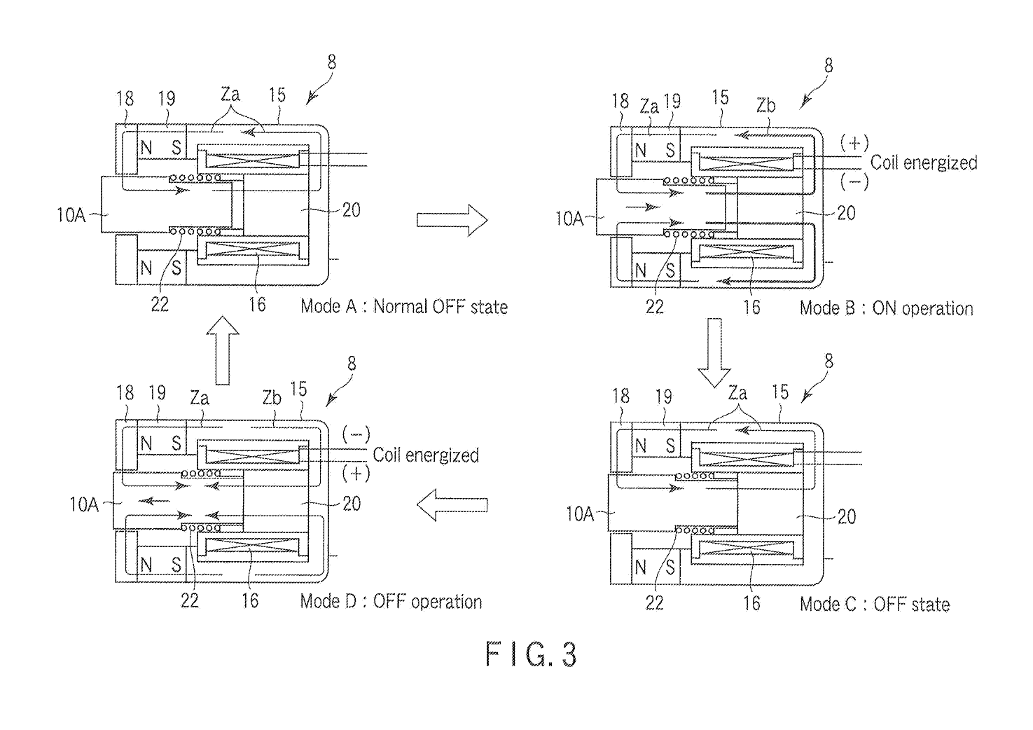

Next, an explanation will be given of the flow of magnetic flux in the solenoid unit 8, based on modes A to D shown in FIG. 3. FIG. 3 is a schematic explanatory diagram showing the flow of magnetic flux in the solenoid unit.

In the solenoid unit 8, the plunger 10A and tube cap 20 are located along the axis line as described above. A coil 16, an outer yoke 15, a permanent magnet 19, and a washer 18 are provided around the outer periphery of the plunger.

When the coil 16 is energized, a magnetic circuit that flows a magnetic flux is sequentially generated in the outer yoke 15, permanent magnet 19, washer 18, plunger 10A, tube cap 20, and outer yoke 15.

In mode A in FIG. 3, the coil 16 is being not energized, and a magnetic flux Za of the permanent magnet 19 is being generated, but not so strong to move (actuate) the plunger 10A. This is the normal OFF state.

At this time, the elastic force of the compression spring 22 is being applied to the plunger 10A, one end of the plunger 10A is separated from the tube cap 20, and the other end the plunger 10A is projected from the washer 18. In other words, this state corresponds to the special operation explained in FIG. 2, in which the valve body 10 formed as one body with the plunger 10A closes the first inflow port 25 in the first chamber M1, and the second inflow port 26 communicates with the outflow port 2 through the internal flow path 11 of the valve body 10.

Next, in mode B in FIG. 3, the coil 16 is energized, and a magnetic flux Zb is generated in the outer yoke 15. At this time, the coil 16 is set to positive (+) and negative (−), so that the magnetic flux Zb, which is the same direction as the magnetic flux Za that is always generated by the permanent magnet 19 in the direction (counterclockwise) indicated in the drawing, is generated in the outer yoke 15.

An ON operation is performed by the above, and the magnetic flux Za that is usually generated by the permanent magnet 19 is combined with the magnetic flux Zb that is generated in the outer yoke 15 by energizing, in the same direction (counterclockwise). As a result, the combined magnetic fluxes Za and Zb act on the plunger 10A as a magnetic force larger than the elastic energizing force of the compression spring 22.

The plunger 10A is moved to the right in the drawing against the elastic force of the compression spring 22, and is finally absorbed by the tube cap 20. As in the normal operation mode explained in FIG. 1, the valve body closes the second chamber M2 by the movement of the plunger 10A, and the first inflow port 25 communicates with the outflow port 2.

After the plunger 10A is moved, power supply to the coil 22 is stopped in mode C in FIG. 3. The operation goes into the OFF state, in which the magnetic flux Zb of the outer yoke 15 is lost, and only the magnetic flux Za of the permanent magnet 19 is kept.

By the magnetic flux Za of the permanent magnet 19, the attractive forces of the magnetic poles formed in the end faces of the plunger 10A and tube cap 20 (north pole in the plunger 10A, and south pole in the tube cap 20) maintain the absorbed state (ON state) against the elastic force of the compression spring 22. In other words, even if the solenoid unit 8 is deenergized after once energized, the magnetic flux Za of the permanent magnet 19 maintains the positions of the plunger 10A and valve body 10, and the normal operation state shown in FIG. 1 is continued.

To stop normal operation, an OFF operation is executed for the solenoid unit 8. At this time, the coil 16 is energized, but the polarities (+) and (−) are reversed to the state explained in mode B. The direction of the magnetic flow Za in the permanent magnet 19 is unchanged, but the direction of the magnetic flux Zb generated in the outer yoke 15 is reversed.

The permanent magnet 19 cancels the magnetic poles formed in the end faces of the plunger 10A and tube cap 20, and the magnetic attractive force is lost. Receiving the elastic force of the compression spring 22, the plunger 10A is moved and energized in the direction of separating from the tube cap 20. In this state, power supply to the solenoid unit 8 is stopped.

Finally, the operation returns to the normal OFF state, mode A in FIG. 3. In this OFF state, the spring load and permanent magnet strength are set to the degree at which the plunger 10A is not moved by the magnetic attractive force.

When the coil 16 is energized to execute the ON operation in mode B, a momentarily large current (magnetomotive force) is required to magnetically absorb the plunger 10A. Thus, though indicated by a thick line, the OFF operation in mode D is executed for the purpose of canceling the magnetic force of the permanent magnet 19, a required current is small, and this operation is indicated by a thin line.

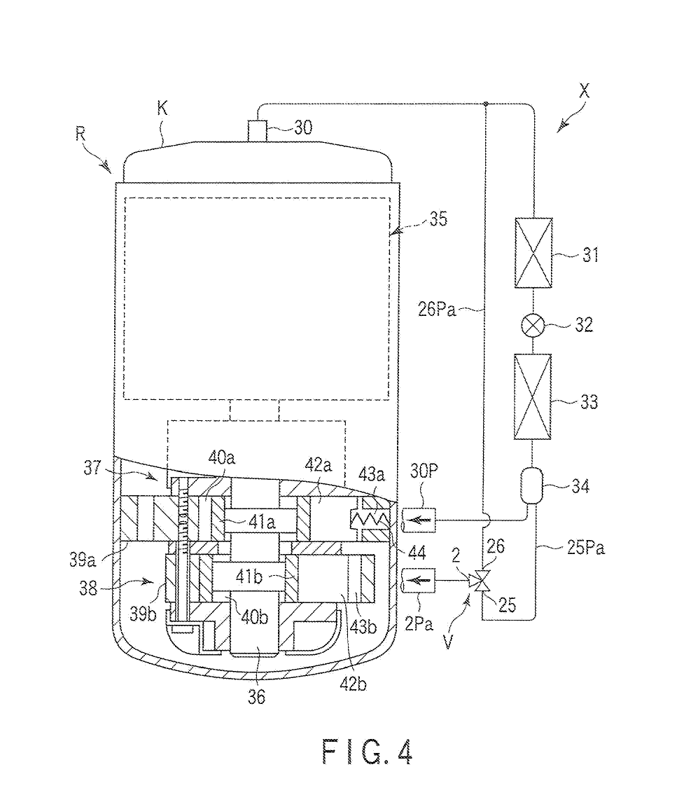

FIG. 4 shows a schematic block diagram of a rotary compressor R which constitutes refrigeration cycle equipment X by using the three-way solenoid valve V in a two-cylinder rotary compressor R, and a configuration of a refrigeration cycle of the refrigeration cycle equipment X. (To simplify the drawing, some parts are not shown, or not given reference numbers, though they are explained.)

First, an explanation will be given of a configuration of a refrigeration cycle of the refrigeration cycle equipment X. R denotes a rotary compressor. A refrigerant discharge tube 30 is connected to the upper surface of the rotary compressor. The refrigerant discharge tube 30 is sequentially connected to a condenser 31, an expansion unit 32, an evaporator 33, and an accumulator 34.

A first refrigerant suction tube 30P and a second refrigerant suction tube 25Pa to be described are extended from the bottom of the accumulator 34. Particularly, the second refrigerant suction tube 25Pa is provided with the three-way solenoid valve V, and is connected to the rotary compressor R through a suction tube 2Pa.

In the rotary compressor R, K denotes a sealed case. The sealed case K contains an electric motor unit 35, and a first compressor mechanism 37 and a second compressor mechanism 38, which are connected to the electric motor unit 35 through an axis of rotation 36.

In addition to the first and second compression mechanisms 37 and 38, rollers 41a and 41b are housed concentrically and rotatably in cylinder chambers 40a and 40b provided in cylinders 39a and 39b. The inner surfaces of the rollers 41a and 41b are fitted to an eccentric part provided eccentrically in the axis of rotation 36, and the outer surfaces receive back pressure and contact the distal end portions of vanes 42a and 42b (or may not contact as described later).

In the state in which, the distal end portions of the vanes 42a and 42b contact the rollers 41a and 41b, the vanes 42a and 42b divide the cylinder chambers 40a and 40b into two chambers. A suction port is provided in one of the chambers, and a discharge port is provided in the other chamber. The first refrigerant suction tube 302 communicates with the suction port provided in the cylinder 39a of the first compression mechanism 37.

The suction tube 2Pa communicates with the suction port provided in the cylinder 39b of the second compression mechanism 38. The discharge port communicates with the inside of the sealed case K directly or through guide paths provided in the cylinders 39a and 39b.

The vane 42a used in the first compression mechanism 37 is housed in the vane chamber 43a, and is configured to receive back pressure by a spring 44 provided between the rear end portion of the vane 42a and the rear wall of the vane chamber 43a. The vane 42b used in the second compression mechanism 38 is housed in the vane chamber 43b, but the vane chamber 43b is exposed to the inside of the sealed case K, and nothing directly contacts the rear end portion of the vane 42b.

Concerning the vane 42b used in the second compression mechanism 38, as the vane chamber 43b is exposed to the inside of the sealed case K, the pressure in the sealed case K influences the vane chamber 43b, and acts as back pressure to the rear end portion of the vane 42b.

The first refrigerant suction tube 30P extended from the bottom of the accumulator 34 is connected to the cylinder 39a that constitutes the first compression mechanism 37, penetrating through the sealed case K, and communicates with the suction port provided there.

The suction tube 2Pa, which is communicating with the second refrigerant suction tube 25Pa and three-way solenoid valve V, is connected to the cylinder 39b that constitutes the second compression mechanism 38, penetrating through the sealed case K, and communicates with the suction port provided there.

A branch refrigerant discharge tube 26Pa is connected to a mid-portion of the refrigerant discharge tube 30 which connects the sealed case K to the condenser 31. The branch refrigerant discharge tube 26Pa is connected to the three-way solenoid valve V. In such a configuration, the three-way solenoid valve V constitutes a switching means as described later.

Further, in the three-way solenoid valve V explained in FIGS. 1 and 2, instead of the first inflow tube 25P connected to the first inflow port 25 provided in the valve box 1, the second refrigerant suction tube 25Pa extended from the bottom of the accumulator 34 is connected.

Instead of the second inflow tube 26P connected to the second inflow port 26, the branch refrigerant discharge tube 26Pa branched from the refrigerant discharge tube 30 is connected. Instead of the outflow tube 2P connected to the outflow port 2, the suction tube 2Pa that is communicating with the suction port of the cylinder 39b in the second compression mechanism 38 is connected.

In the normal operation state as explained in FIG. 1, the first inflow Sport 25 communicates with the outflow port 2 in the three-way solenoid valve V. Thus, in the configuration shown FIG. 4, the second refrigerant suction tube 25Pa from the accumulator 34 communicates with the suction tube 2Pa connected to the suction port of the cylinder 39b of the second compression mechanism 38, through the three-way solenoid valve V.

In the special operation state as explained in FIG. 2, the second inflow port 26 communicates with the outflow port 2 in the three-way solenoid valve V. Thus, in the configuration shown FIG. 4, the branch refrigerant discharge tube 26Pa branched from the refrigerant discharge tube 30 of the sealed case K communicates with the suction tube 2Pa connected to the suction port of the cylinder 39b of the second compression mechanism 38, through the three-way solenoid valve V.

In particular, applying the normal operation explained in FIG. 1 to the configuration of FIG. 4, a low-pressure refrigerant is led from the accumulator 34 to the cylinder chamber 40b of the second compression mechanism 38, through the three-way solenoid valve V. Applying the special operation explained in FIG. 2 to the configuration of FIG. 4, a high-pressure refrigerant immediately after being discharged is led from the sealed case K to the cylinder chamber 40b of the second compression mechanism 38, through the three-way solenoid valve V.

Next, an explanation will be given of the functions of the rotary compressor R and refrigeration cycle equipment X.

In normal operation, the electric motor unit 35 eccentrically rotates and drives the roller 41a of the first compression mechanism 37, and eccentrically rotates and drives the roller 41b of the second compression mechanism 38. In the first compression mechanism 37, the vane 42a receives back pressure by the spring 44, and divides the cylinder chamber 40a into a suction chamber and a compression chamber.

A low-pressure refrigerant is led from the accumulator 34 to the suction chamber through the first refrigerant suction tube 30P, and compressed by the eccentric rotation of the roller 41a. When the compressed refrigerant reaches a predetermined high pressure, it is discharged from the cylinder chamber 40a into the sealed case K, and filled in the sealed case K, making the inside of the case K high-pressure atmosphere.

On the other hand, a low-pressure refrigerant is led from the accumulator 34 to the cylinder chamber 40b of the second compression mechanism 38 through the second refrigerant suction tube 25Pa, three-way solenoid valve V, and suction tube 2Pa. The vane chamber 43b is exposed to the inside of the sealed case K, and is influenced by the pressure in the sealed case K.

In other words, in the second compression mechanism 38, a low-pressure refrigerant is led to the cylinder chamber 40b, and the distal end of the vane 42b is under low-pressure environment. On the other hand, the vane chamber 43b in which the rear end portion of the vane 42b is positioned is under high-pressure environment that is the pressure atmosphere of the sealed case K. A pressure difference is generated between the distal end portion and rear end portion of the vane 42b, and the vane 42b receives back pressure equivalent to the pressure difference.

The vane 42b of the second compression mechanism 38 receives back pressure equivalent to a pressure difference between the inside of the sealed case K and the cylinder chamber 40b, instead of the spring 44 which applies back pressure to the vane 42a of the first compression mechanism 37.

The distal end of the vane 42b follows the eccentric rotation of the roller 41b, always contacts the peripheral surface of the roller, and divides the cylinder chamber 40b into a suction chamber and a compression chamber. Finally, the second compression mechanism 38 performs the same compression as the first compression mechanism 37 does, and full-capacity operation is performed, in which a refrigerant is simultaneously compressed in two cylinder chambers 40a and 40b.

Further, by using full-capacity operation at startup of operation, a stable operation is achieved in a short time. At this time, the three-way solenoid valve V is switched as described above, so that the branch refrigerant discharge tube 26Pa communicates with the suction tube 2Pa that is communicating with the cylinder chamber 40b in the second compression mechanism 38.

As the spring 44 continuously applies back pressure to the vane 42a in the first compression mechanism 37, a normal compression operation is performed, and a high-pressure refrigerant gas is discharged to the inside of the sealed case K. By switching the three-way solenoid valve V, the high-pressure refrigerant gas discharged from the sealed case K is directly led to the cylinder chamber 40b of the second compression mechanism 38 through the branch refrigerant discharge tube 26Pa.

The cylinder chamber 40b of the second compression mechanism 38 becomes high-pressure atmosphere, as in the sealed case K and vane chamber 43b. The distal end portion and rear end portion of the vane 42be become the same high-pressure state, and no pressure difference is generated. Thus, once the vane 42b is pushed back by the eccentric rotation of the roller 41b, and it maintains the position.

Since the distal end of the vane 42b does not contact the peripheral surface of the roller 41b, the cylinder chamber 40b is not divided into a suction chamber and a compression chamber, and the roller 41b simply continues an idle operation. In the rotary compressor R, the first compression mechanism 37 compresses a refrigerant, but the second compression mechanism 38 does not compress a refrigerant (a non-compression operation), and a compression capacity is reduced by half, that is special operation.

By using the three-way solenoid valve V as a switching means as described above, the operation can be easily and securely switched from full-capacity normal operation to half-capacity special operation.

The applicant discloses a rotary compressor and refrigeration cycle equipment, which are designed based on the same spirit and characteristics, in a document 3 (Japanese Patent No. 2004-301114).

As a means of switching from full-capacity operation to half-capacity operation, the document explains use of one of combination of a two-way valve and check valve, a three-way switching valve, and a four-way switching valve used in ordinary heat pump refrigeration cycle equipment.

However, the number of parts is increased in the combination of a two-way valve and check valve. A four-way switching valve cannot be used without modification, and needs to close one piping connection port, requiring time and labor.

Therefore, the three-way solenoid valve V explained hereinbefore is used as a three-way switching valve. This prevents increase in the number of parts, saves time and labor, and improves the workability in manufacturing and assembling.

As long as the setting of the suction tube 2Pa, which communicates with the suction port of the cylinder chamber 40b of the second compression mechanism 38, as a connecting destination of the outflow port 2 in the three-way solenoid valve V is not changed, the connecting destinations of the first inflow port 25 and second inflow port 26 may be reversed.

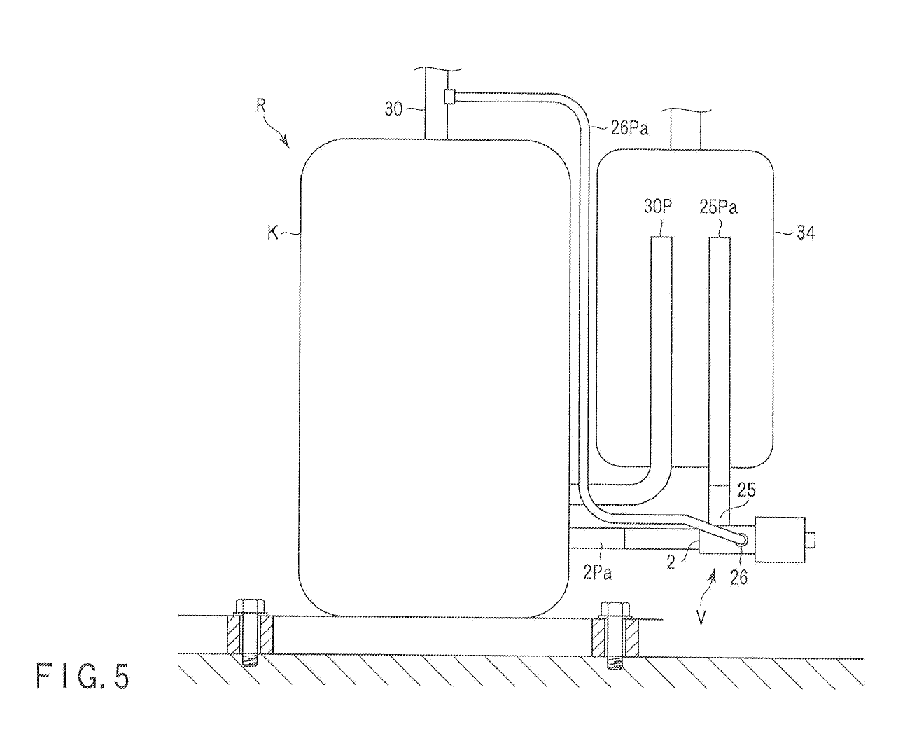

FIG. 5 is a schematic diagram explaining the configuration structure of the three-way solenoid valve V for the rotary compressor R and accumulator 34.

Two refrigerant suction tubes 30P and 25Pa are extended from the accumulator 34. One refrigerant suction tube 30P is directly connected to the rotary compressor R. The other refrigerant suction tube 25Pa is connected to the three-way solenoid valve V, and the suction tube 2Pa connected to the three-way solenoid valve V is connected to the rotary compressor R.

The first inflow port 25 of the three-way solenoid valve V is connected to the refrigerant suction tube 25Pa that is communicating with the accumulator 34, and the second inflow port 26 is connected to the branch refrigerant discharge tube 26Pa that is branched from the refrigerant discharge tube 30 of the rotary compressor R. The outflow port 2 is connected to the suction tube 2Pa.

The most necessary thing is to locate the three-way solenoid valve V below the accumulator 34, so that at least a part of it is positioned within a projection area of the accumulator 34. In other words, the three-way solenoid valve V is located, so that at least a part of it is overlapped with the position of the accumulator 34 in its axial direction. Therefore, the installation space of the three-way solenoid valve V can be reduced.

Further, as the second inflow port 26 is connected to the branch refrigerant discharge tube 26Pa, a switching mechanism can be incorporated in the compressor R as a single unit, piping and connecting work is unnecessary in manufacturing the refrigeration cycle equipment, and the manufacturability of the refrigeration cycle equipment can be improved.

As the three-way solenoid valve V is located immediately under the accumulator 34, refrigerant piping of refrigeration cycle equipment having no switching means can be used without modification, and productivity is improved.

The invention is not limited to the embodiments described hereinbefore. The invention may be embodied by modifying the constituent elements in practical phases without departing from it spirit and characteristics. The invention may be embodied in various forms by appropriately combining the constituent elements disclosed in the embodiments described hereinbefore.

According to the invention, there is provided a three-way solenoid valve which is simplified in structure and improved in reliability, a rotary compressor which is provided with the three-way solenoid valve in the inflow side of a two-cylinder compression mechanism, and refrigeration cycle equipment which is provided with the rotary compressor for constituting a refrigeration cycle.

What is claimed is:

1. A three-way solenoid valve comprising:
a cylindrical valve box in which a first valve seat is provided at one end, an outflow port is opened, and a second valve seat is provided at a position apart in an axial direction from the first valve seat;
a valve body which is provided movably back and forth in the valve box, and has an internal flow path whose one end is opened in the end face of the outflow port, and the other end is opened on the side;
a solenoid unit which is located at the other end of the valve box, has a plunger provided as one body with the valve body, and drives the valve body together with the plunger;
a sealing means which seals the space between the valve box and valve body, and divides the internal space of the valve box into a first chamber opposing the first valve seat, and a second chamber opposing the second valve seat; and
a first inflow port which is provided in the first chamber, and is opened in the direction substantially orthogonal to the axis line of the valve box, and a second inflow port which is provided in the second chamber, and is opened in the direction substantially orthogonal to the axis line of the valve box,
wherein the first inflow port communicates with the outflow port when the valve body contacts the second valve seat, and the second inflow port communicates with the outflow port through the internal flow path of the valve body when the valve body contacts the first valve seat.

2. The three-way solenoid valve according to claim 1, wherein the solenoid unit is provided with a permanent magnet, which maintains the positions of the plunger and valve body by a magnetic force, even if power supply to the coil is stopped after the plunger and valve body are moved.

3. A rotary compressor comprising:
a sealed case which contains an electric motor unit, a first compression mechanism connected to the electric motor unit, and a second compression mechanism configured to apply back pressure to a vane by internal pressure of the case; and
a switching means which is provided in a gas suction path connected to a cylinder chamber of the second compression mechanism, and is configured to switch connection of the cylinder chamber to a low-pressure side of a refrigeration cycle or a high-pressure side of a refrigeration cycle including a space inside the sealed case, and to lead a low-pressure refrigerant into the cylinder chamber to perform normal compression, or to lead a high-pressure refrigerant into the cylinder chamber to perform idle operation,
wherein the switching means comprises the three-way solenoid valve according to the claim 1, connects an outflow port of the three-way solenoid valve to the downstream of the gas suction path connected to the cylinder chamber of the second compression mechanism, connects one of the first inflow port and second inflow port to the upstream of the gas suction path, and connects the other ends of the first inflow port and second inflow port to the high-pressure side of the refrigeration cycle.

4. The rotary compressor according to claim 3, wherein an accumulator is provided in the upstream of the gas suction path, and the three-way solenoid valve is provided below the accumulator, so that at least a part of the valve is overlapped on the accumulator in the axial direction of the accumulator.

5. Refrigeration cycle equipment comprising the rotary compressor according to claim 3 or claim 4, a condenser, an expansion unit, and an evaporator.
